(19) United States
(12) Patent Application Publication
(10) Pub. No.: US 2012/0144304 A1
(43) Pub. Date: Jun. 7, 2012

(54) SYSTEM AND METHOD FOR REDUCING ARTIFACTS IN IMAGES

(76) Inventors: Ju Guo, Arcadia, CA (US); Ying Luo, Stevenson Ranch, CA (US); Joan Llach, Princeton, NJ (US)

(21) Appl. No.: 13/389,465

(22) PCT Filed: Aug. 12, 2009
(86) PCT No.: PCT/US2009/004612

§ 371 Date: Feb. 8, 2012

(51) Int. Cl. G06F 3/01

(52) U.S. Cl. 715/719

(57) ABSTRACT

A system and method reduce artifacts in images in a manner that efficiently incorporates user feedback, minimizes user effort, and adaptively processes images. According to one exemplary embodiment, the method includes executing an algorithm to remove artifacts in a first region of a first frame, regions outside of the first region being unaffected; identifying a second region of a second frame following the first frame, the second region of the second frame corresponding to the first region of the first frame; displaying the second frame with an indication of the second region; receiving a first user input defining a third region inside the second region; and executing the algorithm to remove artifacts in the second region excluding the third region.

### BACKGROUND OF THE INVENTION

1. Field of the Invention

The present invention generally relates to digital image processing and display systems, and more particularly, to a system and method for reducing artifacts in images that, among other things, efficiently incorporates user feedback, minimizes user effort, and adaptively processes images.

2. Background Information

Image artifacts are noticed during processing of a digital image, or images such as a sequence of images in a film. A common artifact phenomenon is banding (also known as false contouring) where bands of varying intensity and color levels are displayed on an original smooth linear transition area of the image. Processing such as color correction, scaling, color space conversion, and compression can introduce the banding effect. Banding is most prevalent in animation material where the images are man-made with high frequency components and minimum noise. Any processing with limited bandwidth will unavoidably cause alias, “ringing” or banding.

Existing image processing systems typically process images based on low-level features. With such systems, most human interaction involves an initial setup of processing parameters. After processing, the results are evaluated by a user/operator. If a desired result is not achieved, new parameters may be used to re-process the image. For video processing, due to the large number of frames that need to be processed, this approach requires extensive effort. With existing video processing systems, the same initial setting is typically applied to all video frames. However, if an error occurs in the process, the process is canceled and the user may restart the process by re-inputting new parameters. These types of existing systems are less than optimal, and may be quite inconvenient for users. Moreover, they fail to adequately take user feedback information into account during the execution of the process.

Accordingly, there is a need for a system and method for reducing artifacts in images that addresses the foregoing problems. The present invention described herein addresses these and/or other issues, and provides a system and method for reducing artifacts in images that, among other things, efficiently incorporates user feedback, minimizes user effort, and adaptively processes images.

### SUMMARY OF THE INVENTION

In accordance with an aspect of the present invention, a method for processing a moving picture including a plurality of frames is disclosed. According to an exemplary embodiment, the method comprises executing an algorithm to remove artifacts in a first region of a first frame, regions outside of the first region being unaffected; identifying a second region of a second frame following the first frame, the second region of the second frame corresponding to the first region of the first frame; displaying the second frame with an indication of the second region; receiving a first user input defining a third region inside the second region; and executing the algorithm to remove artifacts in the second region excluding the third region.

In accordance with another aspect of the present invention, another method for processing a moving picture including a plurality of frames is disclosed. According to an exemplary embodiment, the method comprises executing an algorithm to remove artifacts in a first region of a first frame, regions outside of the first region being unaffected; identifying a second region of a second frame following the first frame, the second region of the second frame corresponding to the first region of the first frame; displaying the second frame with an indication of the second region; receiving a first user input defining a third region; and executing the algorithm to remove artifacts in a combined region formed by the second region and the third region.

In accordance with still another aspect of the present invention, a system for processing a moving picture including a plurality of frames is disclosed. According to an exemplary embodiment, the system comprises first means such as memory for storing data including an algorithm, and second means such as a processor for executing the algorithm to remove artifacts in a first region of a first frame, regions outside of the first region being unaffected. The second means identifies a second region of a second frame following the first frame, the second region of the second frame corresponding to the first region of the first frame. The second means enables display of the second frame with an indication of the second region. The second means receives a first user input defining a third region inside the second region and executes the algorithm to remove artifacts in the second region excluding the third region.

In accordance with yet another aspect of the present invention, another system for processing a moving picture including a plurality of frames is disclosed. According to an exemplary embodiment, the system comprises first means such as memory for storing data including an algorithm, and second means such as a processor for executing said algorithm to remove artifacts in a first region of a first frame, regions outside of the first region being unaffected. The second means identifies a second region of a second frame following the first frame, the second region of the second frame corresponding to the first region of the first frame. The second means enables display of the second frame with an indication of the second region. The second means receives a first user input defining a third region and executes the algorithm to remove artifacts in a combined region formed by the second region and the third region.

In accordance with yet another aspect of the present invention, another method for processing a moving picture including a plurality of frames is disclosed. According to an exemplary embodiment, the method comprises displaying a frame with an indication of a first region which was tracked from a previous frame; receiving a user input defining a second region inside the first region; and executing an algorithm to remove artifacts in the first region excluding the second region.

In accordance with still yet another aspect of the present invention, another method for processing a moving picture including a plurality of frames is disclosed. According to an exemplary embodiment, the method comprises displaying a frame with an indication of a first region which was tracked from a previous frame; receiving a user input defining a second region; and executing an algorithm to remove artifacts in a combined region formed by the first region and the second region.

In accordance with still yet another aspect of the present invention, another method for processing a moving picture including a plurality of frames is disclosed. According to an exemplary embodiment, the method comprises executing a first algorithm to remove artifacts in a first region of a first frame, regions outside of the first region being unaffected; identifying a second region of a second frame following the first frame, the second region of the second frame corresponding to the first region of the first frame; displaying the second frame with an indication of the second region; receiving a user input defining a third region inside the second region; and executing a second algorithm different from the first algorithm to remove artifacts in the second region excluding the third region.

In accordance with still yet another aspect of the present invention, another method for processing a moving picture including a plurality of frames is disclosed. According to an exemplary embodiment, the method comprises executing a first algorithm to remove artifacts in a first region of a first frame, regions outside of the first region being unaffected; identifying a second region of a second frame following the first frame, the second region of the second frame corresponding to the first region of the first frame; displaying the second frame with an indication of the second region; receiving a user input defining a third region; and executing a second algorithm different from the first algorithm to remove artifacts in a combined region formed by the second region and the third region.

In accordance with still yet another aspect of the present invention, another method for processing a moving picture including a plurality of frames is disclosed. According to an exemplary embodiment, the method comprises executing an algorithm using first parameters to remove artifacts in a first region of a first frame, regions outside of the first region being unaffected; identifying a second region of a second frame following the first frame, the second region of the second frame corresponding to the first region of the first frame; displaying the second frame with an indication of the second region; receiving a first user input defining a third region inside the second region; and executing the algorithm using second parameters different from the first parameters to remove artifacts in the second region excluding the third region.

In accordance with still yet another aspect of the present invention, another method for processing a moving picture including a plurality of frames is disclosed. According to an exemplary embodiment, the method comprises executing an algorithm using first parameters to remove artifacts in a first region of a first frame, regions outside of the first region being unaffected; identifying a second region of a second frame following the first frame, the second region of the second frame corresponding to the first region of the first frame; displaying the second frame with an indication of the second region; receiving a first user input defining a third region; and executing the algorithm using second parameters different from the first parameters to remove artifacts in a combined region formed by the second region and the third region.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a block diagram of a system for reducing artifacts in images according to an exemplary embodiment of the present invention;

FIG. 2 is a block diagram providing additional details of the smart kernel of FIG. 1 according to an exemplary embodiment of the present invention;

FIG. 3 is a flowchart illustrating steps for reducing artifacts in images according to an exemplary embodiment of the present invention;

FIG. 4 is a diagram illustrating an initially selected region of interest according to an exemplary embodiment of the present invention;

FIG. 5 is a diagram illustrating how a user may modify a region of interest according to an exemplary embodiment of the present invention; and

FIG. 6 is a diagram illustrating how a user may modify a region of interest according to another exemplary embodiment of the present invention.

The exemplifications set out herein illustrate preferred embodiments of the invention, and such exemplifications are not to be construed as limiting the scope of the invention in any manner.

### DESCRIPTION OF THE PREFERRED EMBODIMENTS

It should be understood that the elements shown in the drawings may be implemented in various forms of hardware, software or combinations thereof. Preferably, these elements are implemented in a combination of hardware and software on one or more appropriately programmed general-purpose devices, which may include a processor, memory and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents, as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the drawings may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the drawings are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

Most existing image processing techniques operate on an image pixel level, and use low level features, such as brightness and color information. Most of these techniques exploit statistical models based on spatial correlation to achieve better result. If multiple frames of the images are available, frame correlation can also be exploited to improve the image processing result. However, because image processing is based on low level features of the image, image processing sometimes not only fails to remove the existing artifacts, but also introduces additional artifacts into the image. Semantic content-based image processing is still a challenge today.

Region of interest (ROI) based image processing applies image processing to a particular region of an image that contains artifacts, or undesired features that need to be changed. By selectively processing part of an image, ROI can achieve better results than traditional image processing techniques. However, there is still an open question on how to identify the region of interest in a robust and efficient manner. Automatic approaches use color, luminance information to segment or detect certain features or variation of that features. Based on a set of features, an image is classified into regions, and regions with most of the features are classified as a region of interest. For digital intermediaries or digital video processing, region detection is required to be consistent across the frames to avoid artifacts, such as flickering and blurring. Regions are often defined as a rectangle or polygon. In some applications, such as region-based color correction and depth map recovery from 2D images, the region boundary is required to be precisely defined to pixel-wise accuracy.

A semantic object is a set of regions that pose a semantic meaning to humans. Typically, the set of regions shares common low-level features. For example, regions of a sky will have saturated blue colors. Regions of a car will have similar motions. However, sometimes a semantic object contains regions with no obvious similarity in low-level features. Thus, grouping a set of regions to generate a semantic object often fails to achieve the desired goal. This originates from the fundamental difference between the human brain's processing and computer-based image processing. Humans use knowledge to identify semantic objects, while computer-based image processing is based on low-level features. The use of semantic objects will improve the ROI-based image processing significantly in a number of ways. However, the difficulty exists in how to efficiently identify the semantic objects.

According to principles of the present invention, a solution is provided which integrates human knowledge and computer-based image processing to achieve better results (e.g., a semi-automatic or user-assisted approach). In this manner, human interaction can provide intelligent guides for computer-based image processing and thereby achieves better results. Since humans and computers operate in different domains, a challenge is how to map human knowledge to the computer, and maximize the efficiency of human interaction. The cost of human resources is increasing, while the cost of computational power is decreasing. Thus, an efficient tool to integrate human interaction and computer-based image processing will be an invaluable tool for any business that needs to produce better image quality with a low cost benefit.

Currently, most of software tools provide a graphic user interface for an initial setup for the processing parameters, and preview the result before the final processing start. A user can always stop when the result is unsatisfactory and repeat the same process again. With these current systems, however, there is no feedback mechanism to improve the processing by analyzing the user feedback and adapting the system to it. Therefore, the user interaction becomes very inefficient if users are constantly restarting the processing with a new set of parameters.

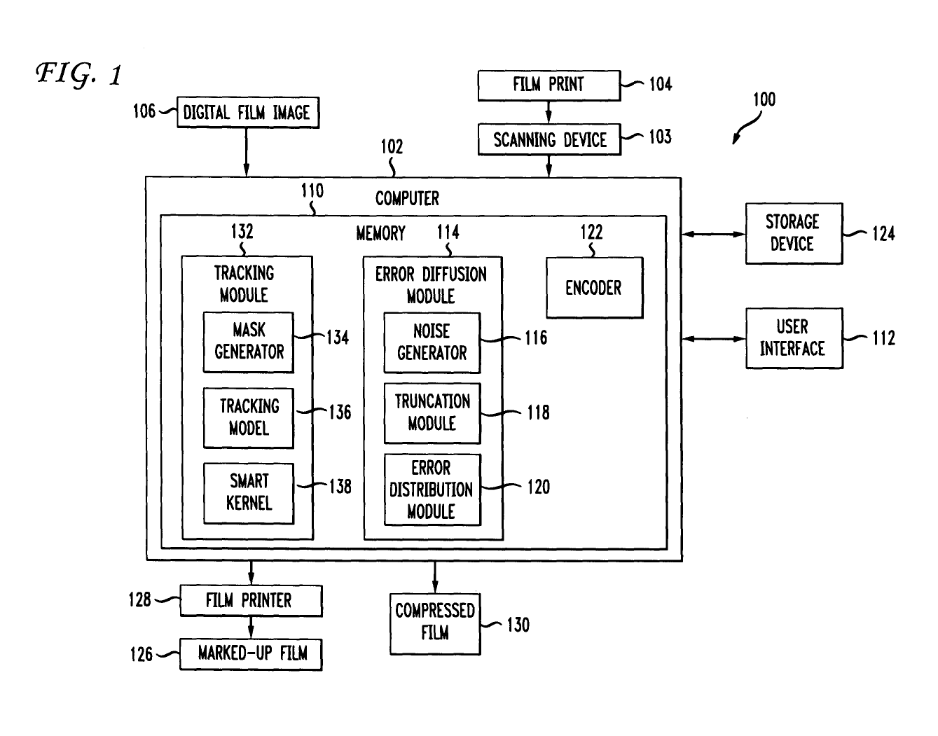

Referring now to the drawings, and more particularly to FIG. 1, a block diagram of a system 100 for reducing artifacts in images according to an exemplary embodiment of the present invention is shown. In FIG. 1, a scanning device 103 may be provided for scanning film prints 104, e.g., camera-original film negatives, into a digital format, e.g. Cineon-format or SMPTE DPX files. Scanning device 103 may comprise, e.g., a telecine or any device that will generate a video output from film such as, for example, an Arri LocPro™ with video output. Alternatively, files representing digital film images 106 from a post production process or digital cinema (e.g., files already in computer-readable form) can be used directly. Potential sources of computer-readable files are AVID™ editors, DPX files, D5 tapes, etc.

Scanned film prints are input to a post-processing device 102, e.g., a computer. Post-processing device 102 is implemented on any of the various known computer platforms having hardware such as one or more central processing units (CPUs), memory 110 such as random access memory (RAM) and/or read only memory (ROM) and input/output (I/O) user interface(s) 112 such as a keyboard, cursor control device (e.g., a mouse, joystick, etc.) and display device. The computer platform also includes an operating system and micro instruction code. The various processes and functions described herein may either be part of the micro instruction code or part of a software application program (or a combination thereof) which is executed via the operating system. In addition, various other peripheral devices may be connected to the computer platform by various interfaces and bus structures, such a parallel port, serial port or universal serial bus (USB). Other peripheral devices may include one or more additional storage devices 124 and a film printer 128. Film printer 128 may be employed for printing a revised or marked-up version of a film 126, e.g., a stereoscopic version of the film. Post-processing device 102 may also generate compressed film 130.

Alternatively, files/film prints already in computer-readable form 106 (e.g., digital cinema, which for example, may be stored on external hard drive 124) may be directly input into post-processing device 102. Note that the term “film” used herein may refer to either film prints or digital cinema.

A software program includes an error diffusion module 114 stored in the memory 110 for reducing artifacts in images. Error diffusion module 114 includes a noise or signal generator 116 for generating a signal to mask artifacts in the image. The noise signal could be white noise, Gaussian noise, white noise modulated with different cutoff frequency filters, etc. A truncation module 118 is provided to determine the quantization error of the blocks of the image. Error diffusion module 114 also includes an error distribution module 120 configured to distribute the quantization error to neighboring blocks.

A tracking module 132 is also provided for tracking a ROI through several frames of a scene. Tracking module 132 includes a mask generator 134 for generating a binary mask for each image or frame of a given video sequence. The binary mask is generated from a defined ROI in an image, e.g., by a user input polygon drawn around the ROI or by an automatic detection algorithm or function. The binary mask is an image with pixel value either 1 or 0. All the pixels inside the ROI have a value of 1, and other pixels have a value of 0. Tracking module 132 also includes a tracking model 136 for estimating the tracking information of the ROI from one image to another, e.g., from frame to frame of a given video sequence.

Tracking module 132 further includes a smart kernel 138 that is operative to interpret user feedback, and adapt it to the actual content of an image. According to an exemplary embodiment, smart kernel 138 automatically modifies an image processing algorithm, and its corresponding parameters based on a user's input and analysis of underlying regions in the image, thereby providing better image processing results. In this manner, the present invention can simplify user operation and alleviate the burden for users having to restart the process when system 100 fails to produce satisfactory results. By adapting the processing of an image to its actual content and user feedback, the present invention provides more efficient image processing with robust and excellent image quality. Further details regarding smart kernel 138 will be provided later herein. Also in FIG. 1, an encoder 122 is provided for encoding the output image into any known compression standard, such as MPEG 1, 2, 4, H.264, etc.

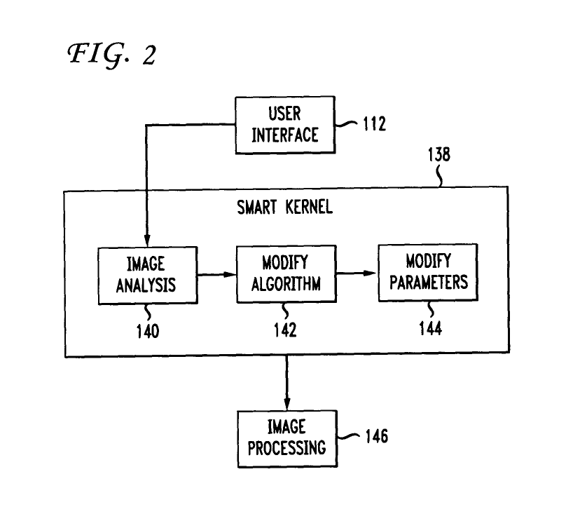

Referring now to FIG. 2, a block diagram providing additional details of smart kernel 138 of FIG. 1 according to an exemplary embodiment of the present invention is shown. According to principles of the present invention, user interface 112 enables users to provide inputs to smart kernel 138, and is an intuitive user interface that users without detailed knowledge of image processing can operate effectively. In particular, user interface 112 allows users to identify problematic areas (i.e., regions of interest) which image processing fails to generate satisfactory results.

As indicated in FIG. 2, smart kernel 138 comprises an image analysis module 140, a modify algorithm module 142 and a modify parameters module 144. According to an exemplary embodiment, once a user identifies a region of interest (ROI) that is not satisfactory after image processing, smart kernel 138 will receive that user feedback information and may modify internal parameters and processing steps in response thereto. The functionality of smart kernel 138 is as follows.

First, image analysis module 140 analyzes image content based on the aforementioned user feedback information, and characterizes (i.e., defines) the one or more regions of interest with unsatisfactory processing results. Once the one or more regions of interest are analyzed, smart kernel 138 may modify an algorithm and/or parameters via modules 142 and 144, respectively. For example, several region tracking algorithms could be used by system 100 to track the set of one or more regions defining the region of interest (e.g., contour-based tracker, feature point-based tracker, texture-based tracker, color-based tracker, etc.). Depending on the characteristics of the regions being tracked (i.e. the output result of image analysis module 140), modify algorithm module 142 will choose the most appropriate tracking method according to design choice. For example, if an initial region of interest is a person's face, but later on the user decides to modify the region of interest (ROI) by adding the person's hair, modify algorithm module 142 of smart kernel 138 may switch from a color-based tracker to a contour-based tracker (i.e., given that face plus hair is not homogeneous in color anymore).

Moreover, even if modify algorithm module 142 does not change the tracking algorithm, as described above, modify parameters module 144 of smart kernel 138 may still decide to change the tracking parameters. For example, if an initial region of interest is a blue sky, and the user later decides to modify the region of interest (ROI) by adding white clouds to the blue sky, modify algorithm module 142 may keep using a color-based tracker, but modify parameters module 144 may change the tracking parameters to track both blue and white (i.e., instead of just blue). As indicated in FIG. 2, outputs from smart kernel 138 are provided for image processing (i.e., tracking processing) at block 146.

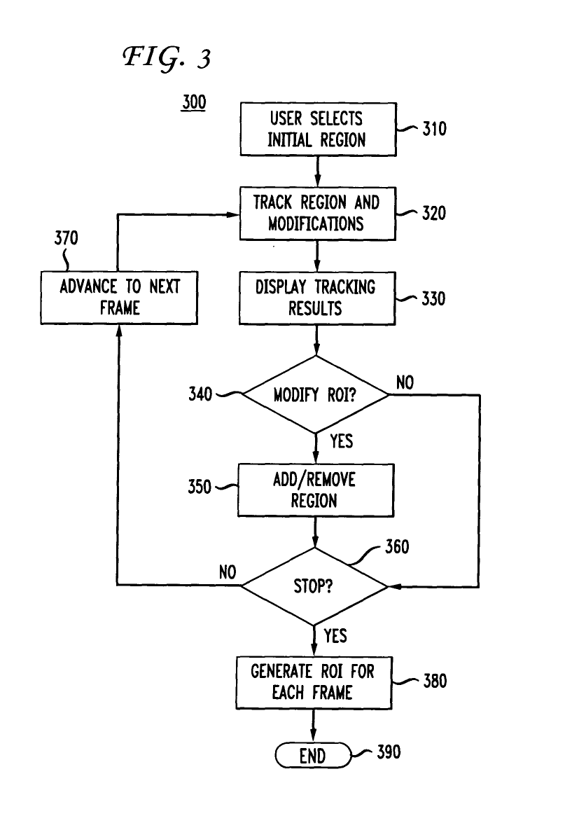

Referring now to FIG. 3, a flowchart 300 illustrating steps for reducing artifacts in images according to an exemplary embodiment of the present invention is shown. For purposes of example and explanation, the steps of FIG. 3 will be described with relation to certain elements of system 100 of FIG. 1. However, it should be intuitive that the steps of FIG. 3 are facilitated by smart kernel 138, as described above. The steps of FIG. 3 are exemplary only, and are not intended to limit the application of the present invention in any manner.

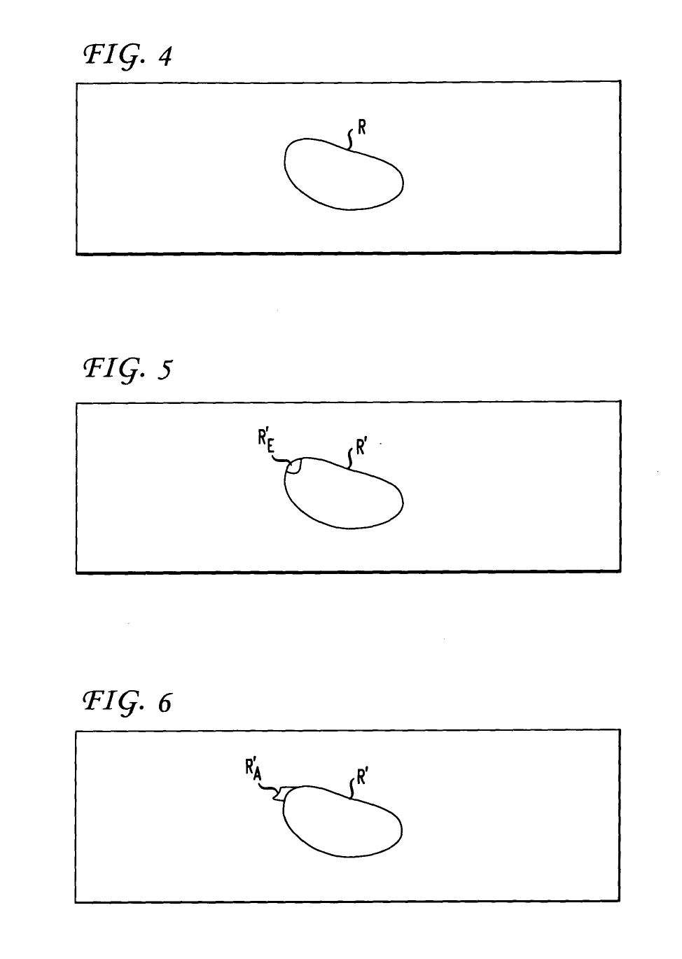

At step 310, a user selects an initial region of interest (ROI) in a given frame of a video sequence. According to an exemplary embodiment, the user can use a mouse and/or other element of user interface 112 at step 310 to outline the initial ROI where a tracking error exists. FIG. 4 illustrates an exemplary ROI (i.e., R) that may be selected at step 310. The simple user interface represented in FIG. 4 allows the user to intuitively identify the ROI at step 310. According to principles of the present invention, the ROI selected at step 310 (and which may be modified for subsequent frames) represents a region where artifacts are present that need to be removed (e.g., via a tracking algorithm using a masking signal).

At step 320, the ROI (including any modifications thereto) is tracked to a next frame in the given video sequence. According to an exemplary embodiment, a 2D affine motion model may be used at step 320 to track the ROI. The tracking modeling can be expressed as follows:

x′=a₁x+b₁y+c₁

y′=a₂x+b₂y+c₂ (1)

where (x, y) is the pixel position in the tracking region R in the previous frame, (x′, y′) is the corresponding pixel position in the tracking region R′ in the current frame, and (a₁,b₁,c₁,a₂,b₂,c₂) are constant coefficients. Given the is region R in the previous frame, the best match of the region R′ in the current frame can be found by minimizing the mean square error of the intensity difference.

According to an exemplary embodiment, the tracking process of step 320 is part of an algorithm that is designed to remove artifacts from the ROI (e.g., via a masking signal), while leaving the remaining regions of the frame unaffected. In particular, system 100 is designed to track and remove the artifacts in a given video sequence of frames. To effectively remove the artifacts, the ROI is identified and a masking signal is added to that specific region to mask out the artifacts. System 100 uses motion information to track the ROI across a number of frames.

At step 330, the tracking results of step 320 are displayed for evaluation by the user. At step 340, the user is provided the option to modify the current ROI. According to an exemplary embodiment, the user makes a determination to add and/or remove one or more regions to and/or from the current ROI at step 340 based on whether he/she detects a tracking error in the tracking results displayed at step 330.

If the determination at step 340 is positive, process flow advances to step 350 where one or more regions are added to and/or removed from the current ROI in response to user input via user interface 112. FIG. 5 illustrates an example where the user has elected to remove a region R′_{E} from tracking region R′. FIG. 6 illustrates an example where the user has elected to add a region R′_{A} to tracking region R′.

From step 350, or if the determination at step 340 is negative, process flow advances to step 360 where a determination is made as to whether the tracking process should be stopped. According to an exemplary embodiment, the user may manually stop the tracking process at his/her discretion at step 360 by providing one or more predetermined inputs via user interface 112. Alternatively, the tracking process may stop at step 360 when the end of the given video sequence is reached.

If the determination at step 360 is negative, process flow advances to step 370 where the process advances to the next frame in the given video sequence. From step 370, process flow loops back to step 320, as described above. Assuming the user has elected to modify the ROI at steps 340 and 350, the modified ROI is tracked to a next frame in the given video sequence at step 320. For example, in FIG. 5 where region R′_{E} was identified by the user, the region will be tracked into the region of R′_{E} of the next frame by the same processing described above at step 320. Thus, the final tracking region for the frame will be expressed as follows:

R_{F}=R′∩ R̅′̅_̅{̅E̅}̅ (2)

where the final tracking region R_{F} is the region R′ with the pixels in region RE removed.

Similarly, for the example of FIG. 6 where the region R_{A} is added by the user, the region will be tracked into the R′_{A} region of the next frame by the same processing described above at step 320. Thus, the final tracking region for the frame will be expressed as follows:

R_{F}=R⁴⁰∪R′_{A} (3)

where the final tracking region R_{F} is the region R′ with the pixels in region R′_{A} added. The steps of FIG. 3 may be repeatedly performed until a positive determination is made at step 360, in which case a final ROI is generated (and stored) for each of the tracked frames in the given video sequence at step 380. The process ends at step 390. Specifically contemplated examples of how the aforementioned principles of the present invention may be implemented in practice are represented in the various dependent claims of this application, and the subject matter of such dependent claims is hereby incorporated by reference into the body of this description in its entirety.

In order to help a user identifying the ROI, the current ROI is clearly is marked. For example, the ROI is displayed with a particular predefined color, such as red, which may be selectable by a user, in response to a user input. The user input may be generated by pressing a key in the user interface. The particular predefined color can be removed in response to the same or a different user input. When the ROI is displayed with the particular predefined color, a region contained in the ROI, which is identified by a user to be excluded from the ROI, should be displayed with a user selected color different from the particular predefined color. When a region specified by a user is outside of the ROI or has overlapped with the ROI, the portion outside of the ROI will be considered to be combined with the ROI to form a new ROI and should be displayed with the particular predefined color. When the particular predefined color is removed, the selected color for indicating the deleted region is also removed.

As described above, the present invention provides a system and method for reducing artifacts in images that efficiently incorporates user feedback, minimizes user effort, and adaptively processes images. In particular, system 100 automatically updates the tracking region and the erroneous regions and effectively uses user feedback information to achieve robust region tracking. A user is only required to define the region with tracking errors, and system 100 will automatically incorporate that information into the tracking process.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure to as come within known or customary practice in the art to which this invention pertains and which fall within the limits of the appended claims.

1. A method for processing a moving picture including a plurality of frames, said method comprising:
executing an algorithm to remove artifacts in a first region of a first frame, regions outside of said first region being unaffected;
identifying a second region of a second frame following said first frame, said second region of said second frame corresponding to said first region of said first frame;
displaying said second frame with an indication of said second region;
receiving a first user input defining a third region inside said second region; and
executing said algorithm to remove artifacts in said second region excluding said third region.

2. The method of claim 1, further comprising steps of:
identifying a fourth region of a third frame following said second frame, said fourth region corresponding to said second region of said second frame excluding said third region; and
executing said algorithm to remove artifacts in said fourth region of said third frame.

3. The method of claim 1, further comprising a step of displaying said third region differently from said second region excluding said third region, and thereby enabling a user to identify which part is included for executing said algorithm.

4. The method of claim 3, further comprising steps of:
receiving a second user input identifying said third region to be included for executing said algorithm; and
removing display of said third region.

5. The method of claim 1, wherein said first region includes a plurality of regions and said third region is part of one of a plurality of regions representing said second region.

6. The method of claim 1, further comprising a step of identifying a fourth region to be included for executing said algorithm.

7. The method of claim 6, further comprising a step of displaying said third region differently from said fourth region and said second region excluding said third region, and thereby enabling a user to identify which part is included for executing said algorithm.

8. A method for processing a moving picture including a plurality of frames, said method comprising:
executing an algorithm to remove artifacts in a first region of a first frame, regions outside of said first region being unaffected;
identifying a second region of a second frame following said first frame, said second region of said second frame corresponding to said first region of said first frame;
displaying said second frame with an indication of said second region;
receiving a first user input defining a third region; and
executing said algorithm to remove artifacts in a combined region formed by said second region and said third region.

9. The method of claim 8, further comprising steps of:
identifying a fourth region of a third frame following said second frame, said fourth region corresponding to said combined region; and
executing said algorithm to remove artifacts in said fourth region of said third frame.

10. The method of claim 8, further comprising steps of:
identifying a fourth region of a third frame following said second frame, said fourth region corresponding to said combined region; and
receiving a second user input defining a fifth region inside said combined region; and
executing said algorithm to remove artifacts in said combined region excluding said fifth region of said third frame.

11-20. (canceled)

21. A system for processing a moving picture including a plurality of frames, said system comprising:
memory operative to store data including an algorithm;
a processor operative to execute said algorithm to remove artifacts in a first region of a first frame, regions outside of said first region being unaffected;
said processor identifying a second region of a second frame following said first frame, said second region of said second frame corresponding to said first region of said first frame;
said processor enabling display of said second frame with an indication of said second region;
said processor receiving a first user input defining a third region inside said second region; and
said processor executing said algorithm to remove artifacts in said second region excluding said third region.

22. The system of claim 21, wherein:
said processor identifies a fourth region of a third frame following said second frame, said fourth region corresponding to said second region of said second frame excluding said third region; and
said processor executes said algorithm to remove artifacts in said fourth region of said third frame.

23. The system of claim 21, wherein said processor enables display of said third region differently from said second region excluding said third region, and thereby enables a user to identify which part is included for executing said algorithm.

24. The system of claim 23, wherein:
said processor receives a second user input identifying said third region to be included for executing said algorithm; and
said processor removes display of said third region.

25. The system of claim 21, wherein said first region includes a plurality of regions and said third region is part of one of a plurality of regions representing said second region.

26. The system of claim 21, wherein said processor identifies a fourth region to be included for executing said algorithm.

27. The system of claim 26, wherein said processor further enables display of said third region differently from said fourth region and said second region excluding said third region, and thereby enables a user to identify which part is included for executing said algorithm.

28. A system for processing a moving picture including a plurality of frames, said system comprising:
memory operative to store data including an algorithm;
a processor operative to execute said algorithm to remove artifacts in a first region of a first frame, regions outside of said first region being unaffected;
said processor identifying a second region of a second frame following said first frame, said second region of said second frame corresponding to said first region of said first frame;
said processor enabling display of said second frame with an indication of said second region;
said processor receiving a first user input defining a third region; and
said processor executing said algorithm to remove artifacts in a combined region formed by said second region and said third region.

29. The system of claim 28, wherein:
said processor identifies a fourth region of a third frame following said second frame, said fourth region corresponding to said combined region; and
said processor executes said algorithm to remove artifacts in said fourth region of said third frame.

30. The system of claim 28, wherein:
said processor identifies a fourth region of a third frame following said second frame, said fourth region corresponding to said combined region;
said processor receives a second user input defining a fifth region inside said combined region; and
said processor executes said algorithm to remove artifacts in said combined region excluding said fifth region of said third frame.

31. A method for processing a moving picture including a
plurality of frames, said method comprising:
displaying a frame with an indication of a first region which was tracked from a previous frame;
receiving a user input defining a second region inside said first region; and
executing an algorithm to remove artifacts in said first region excluding said second region.

32. A method for processing a moving picture including a plurality of frames, said method comprising:
displaying a frame with an indication of a first region which was tracked from a previous frame;
receiving a user input defining a second region; and
executing an algorithm to remove artifacts in a combined region formed by said first region and said second region.

33. A method for processing a moving picture including a plurality of frames, said method comprising:
executing a first algorithm to remove artifacts in a first region of a first frame, regions outside of said first region being unaffected;
identifying a second region of a second frame following said first frame, said second region of said second frame corresponding to said first region of said first frame;
displaying said second frame with an indication of said second region;
receiving a user input defining a third region inside said second region; and
executing a second algorithm different from said first algorithm to remove artifacts in said second region excluding said third region.

34. A method for processing a moving picture including a plurality of frames, said method comprising:
executing a first algorithm to remove artifacts in a first region of a first frame, regions outside of said first region being unaffected;
identifying a second region of a second frame following said first frame, said second region of said second frame corresponding to said first region of said first frame;
displaying said second frame with an indication of said second region;
receiving a user input defining a third region; and
executing a second algorithm different from said first algorithm to remove artifacts in a combined region formed by said second region and said third region.

35. A method for processing a moving picture including a plurality of frames, said method comprising:
executing an algorithm using first parameters to remove artifacts in a first region of a first frame, regions outside of said first region being unaffected;
identifying a second region of a second frame following said first frame, said second region of said second frame corresponding to said first region of said first frame;
displaying said second frame with an indication of said second region;
receiving a first user input defining a third region inside said second region; and
executing said algorithm using second parameters different from said first parameters to remove artifacts in said second region excluding said third region.

36. A method for processing a moving picture including a plurality of frames, said method comprising:
executing an algorithm using first parameters to remove artifacts in a first region of a first frame, regions outside of said first region being unaffected;
identifying a second region of a second frame following said first frame, said second region of said second frame corresponding to said first region of said first frame;
displaying said second frame with an indication of said second region;
receiving a first user input defining a third region; and
executing said algorithm using second parameters different from said first parameters to remove artifacts in a combined region formed by said second region and said third region.
